(19) United States
(12) Patent Application Publication
(10) Pub. No.: US 2017/0245463 A1
(43) Pub. Date: Aug. 31, 2017

(54) Foldable Animal Sustenance Receptacle

(71) Applicant: CleanFeed, LLC, Jamaica Plain, MA (US)

(72) Inventor: Joseph S. Wold, Jamaica Plain, MA (US)

(73) Assignee: CleanFeed, LLC, Jamaica Plain, MA (US)

(21) Appl. No.: 15/367,768

(22) Filed: Dec. 2, 2016

Related U.S. Application Data
(63) Continuation-in-part of application No. 29/555,910, filed on Feb. 25, 2016, now Pat. No. D792660.
Application No. 29/555,910 is a continuation-in-part of application No. 29/571,380, filed on Jul. 18, 2016, now Pat. No. D792661.

(51) Int. Cl. A01K 5/01; A01K 1/035; A01K 7/00

(52) U.S. Cl. CPC A01K 5/0114; A01K 7/00; A01K 1/0356; A01K 5/01

(57) ABSTRACT

A foldable animal sustenance receptacle apparatus comprising a wall mountable structure having a front face and a back face, and at least one receptacle platform, wherein the receptacle platform is operably attached to the front face of the wall mountable structure and extends out perpendicularly from the front face of the wall mountable structure when in the unfolded, horizontal position, is disclosed. The platform can fold upward or downward to be partially flush or fully flush with the front face, and the receptacle platform comprises at least one receptacle for food or water. The receptacles may sit on top of the platform, or the platform may be designed so that receptacles sit within the platform and may be removable or fixed. The present disclosure also provides a system and method for feeding a domesticated animal.

### CROSS REFERENCE TO RELATED APPLICATIONS

This utility patent application claims the benefit of priority and is a Continuation-In-Part from U.S. Design Patent application Ser. No. 29/555,910 filed on Feb. 25, 2016, and U.S. Design application Ser. No. 29/571,380 filed on Jul. 18, 2016, the contents of each of which are incorporated herein by reference in their entireties.

### BACKGROUND

A proper feeding apparatus is important for domesticated animals, such as dogs and cats, as well as other domesticated animals. When domesticated animals eat or drink, they usually place their faces in a bowl or dish containing food or water that sits on the floor. However, elevated feeders offer many benefits, such as comfort for older domesticated animals with arthritis, back, or neck problems, or conditions that make swallowing difficult, such as megaesophagus. They also help keep feeding areas cleaner, as, for example, a dog does not have to raise their head after drinking and thus keeps water off the floor. A foldable, raised feeding apparatus offers the additional benefit to the owner of the domesticated animal in that it can be folded up and stored in a small place.

The foregoing examples of related art and limitations related therewith are intended to be illustrative and not exclusive, and they do not imply any limitations on the inventions described herein. Other limitations of the related art will become apparent to those skilled in the art upon a reading of the specification and a study of the drawings.

### SUMMARY

The following embodiments and aspects thereof are described and illustrated in conjunction with systems, tools and methods, which are meant to be exemplary and illustrative, not limiting in scope. In various embodiments, one or more of the above-described problems have been reduced or eliminated, while other embodiments are directed to other improvements.

One embodiment comprises a foldable animal sustenance receptacle apparatus having folded and unfolded positions comprising a wall mountable structure having a front face and a back face, and at least one receptacle platform, wherein the receptacle platform is operably attached to the front face of the wall mountable structure and extends out perpendicularly from the front face of the wall mountable structure when in the unfolded, horizontal position, wherein said platform can fold upward or downward to be partially flush or fully flush with said front face, and wherein said receptacle platform comprises at least one receptacle for food or water.

Another embodiment may further comprise a method for feeding a domestic animal, comprising providing a foldable animal sustenance receptacle comprising a wall mountable structure having a front face and a back face, and at least one receptacle platform, wherein said platform is operably attached to said front face and extends out approximately perpendicular from said front face when in the unfolded position, wherein said platform can fold upward or downward to be partially flush with said front face, and wherein said platform comprises a receptacle for food or water; moving said receptacle from the closed position to the open position and providing food or water in said receptacle; feeding a domestic animal and then returning said receptacle to the closed position for storage.

An embodiment of the present disclosure comprises a foldable animal sustenance system comprising: a walled platform, having a front face and a back face; and receptacle platform having at least one receptacle for holding food or water; wherein said receptacle platform is operably attached to said walled platform by a means of attachment; and wherein said means of attachment allows the receptacle platform to swing or rotate in a horizontal position, a vertical position, or any position between the horizontal position and the vertical position.

In addition to the example, aspects and embodiments described above, further aspects and embodiments will become apparent by study of the following descriptions, any one or all of which are within the invention. The summary above is a list of example implementations, not a limiting statement of the scope of the invention.

### BRIEF DESCRIPTION OF THE DRAWINGS

The accompanying figures, which are incorporated herein and form a part of the specification, illustrate some, but not the only or exclusive, example embodiments and/or features. It is intended that the embodiments and figures disclosed herein are to be considered illustrative rather than limiting.

FIG. 1 is a front perspective view of a foldable animal sustenance receptacle for animals in the open position.

FIG. 2 is a front perspective view of a foldable animal sustenance receptacle for animals in the closed position.

FIG. 3 is a back view of a foldable animal sustenance receptacle for animals.

FIG. 4 is a right side view of a foldable animal sustenance receptacle for animals in the closed position.

FIG. 5 is a right side view of a foldable animal sustenance receptacle for animals in the open position.

FIG. 6 is a bottom view of a foldable animal sustenance receptacle for animals in the open position.

FIG. 7 is a flow diagram showing a method of using a foldable animal sustenance receptacle system.

FIG. 8 is a front perspective view of an example foldable animal sustenance receptacle system in the silhouette of a cat and in the open position.

### DETAILED DESCRIPTION

One or more embodiments of the present disclosure provide a foldable animal sustenance receptacle system and methods for use. The system allows for elevated feeding for domesticated and wild animals including but not limited to mammals such as dogs, cats, cattle, horses, llamas, alpacas, pigs, as well as birds, such as chickens, turkeys, ostrich, ducks and others. Once the animal has completed eating or drinking, the system folds or swings on a hinge into a position out of the way for easy storage.

As will be discussed in more detail, the foldable animal sustenance receptacle system functions by providing at least one platform operably attached to a wall mountable structure, which may fold or swing upwards or downwards to be substantially flush with the front face of the wall mountable structure. The receptacle platform extends out approximately perpendicular to the front face of the wall mountable structure when in the unfolded or open position and allows for one or more receptacles, or containers, to be placed on or within the platform. As used herein, the phrase “open” refers to the receptacle platform in the unfolded, horizontal position, and “closed” refers to the receptacle platform in the folded, vertical position. The receptacles may be removable or fixed. The system may further comprise a means for support for the platform when in the open position. The back face may further comprise a means for attaching the foldable animal sustenance receptacle on a wall. The present disclosure also provides a method for feeding a domesticated animal.

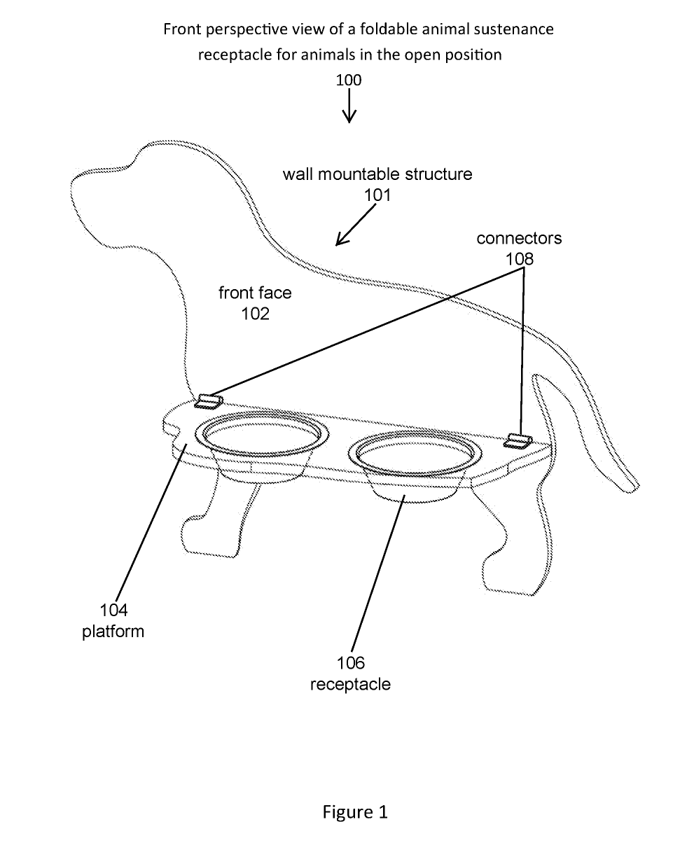

Shown in FIG. 1 is a front perspective view of a foldable animal sustenance receptacle for animals in the open position 100. The foldable animal sustenance receptacle 100 comprises a wall mountable structure 101 having a front face 102 shaped in the silhouette of a dog with a platform 104 operably attached to the front face 102 by connectors 108. The platform 104 shape partially mimics the silhouette of the wall mountable structure 101, so that the silhouette of a dog is maintained when the platform is in the folded or closed position. The foldable animal sustenance receptacle for dogs further comprises receptacles 106 that may act as containers for food or water.

The shape of the foldable animal sustenance receptacle shown in FIG. 1 is shaped in the silhouette of a dog; however, as will be understood by one skilled in the art, a variety of any shapes may be used, including but not limited to, other animal shapes such as a cat, cow, horse, sheep, goat, pig, etc., or standard shapes such as square, circle, oval, triangle, trapezium, diamond, rhombus, parallelogram, pentagon, hexagon, heptagon, octagon, nonagon, and decagon, or words, letters, or logos. Means for affixing or attaching the foldable animal sustenance receptacle to the wall are known to those skilled in the art and may include, for example, VELCRO, screws, bolts, brackets or adhesive materials.

As will be understood by one skilled in the art, a variety of materials may be used to construct wall mountable structure and the receptacle platform of the foldable animal sustenance receptacle including but not limited to, wood, plywood, plasterboard, wallboard, gypsum board, metal, including but not limited to copper, bronze, steel and aluminum or others, stone, plastic, and fiberglass, fabric.

As will be understood by one skilled in the art, the size and shape of the foldable animal sustenance receptacle may be customized for the size and shape of the animal or animals, which the device is intended to be used for.

As will be understood by one skilled in the art, while one receptacle platform is shown in FIG. 1, two, three or more receptacle platforms may be operably attached to the wall mountable structure, depending on the number of animals and needs of the animals using the apparatus.

As will be understood by one skilled in the art, the foldable animal sustenance receptacle may have one, two, three or more receptacles 106 within the receptacle platform. Bowls or other food bearing devices may be used as receptacles and the shape of the receptacles may vary depending on the shape of the silhouette and may include round, oval, square, rectangular, hexagons, pentagons and other shapes.

As shown in FIG. 1 an embodiment of the present disclosure provides a means for operably attaching the platform 104 to the front face 102 of the wall mountable structure 101 via connectors 108. Any number of connectors may be used; for example, hinges, and pistons or other means for controlled folding and unfolding. The platform 104 and/or front face 102 may further comprise a latch, lock, magnetic closure, a hook, a hook and eye bold, a hook and U-connection, nails, wire rope clips, snap hooks, buckles, etc. to maintain the platform upright in the folded or closed position.

Braces or legs (not shown in FIG. 1) may be attached to the receptacle platform. The braces or legs provide additional support to the receptacle platform when in a horizontal or open position and/or when food or water are in the receptacle of the receptacle platform. Chain supports, such as a transom chain, pneumatic lift systems, and stay support hinges may also be used, for example, to provide additional support to the receptacle platform when in the open position.

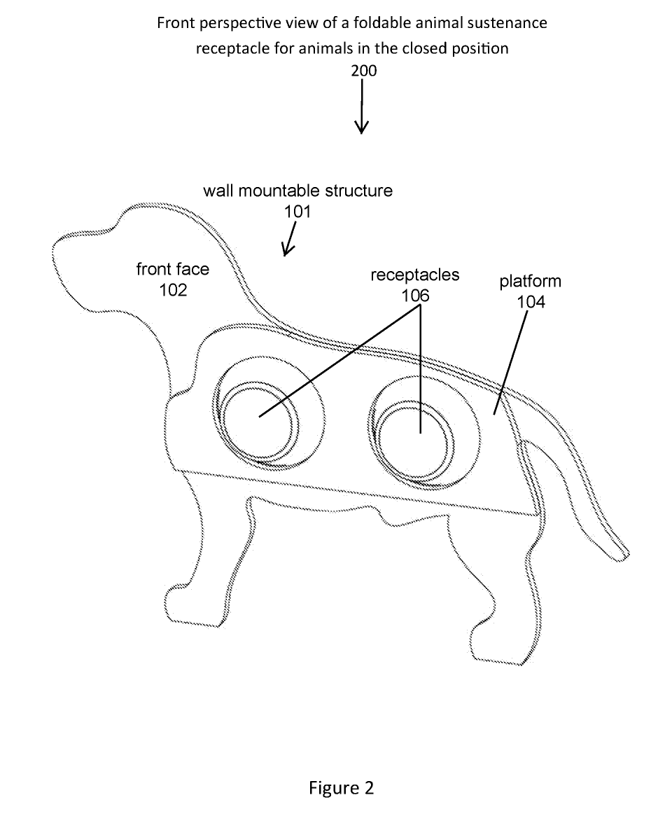

Shown in FIG. 2 is a front perspective view of a foldable animal sustenance receptacle for animals in the closed position 200. The foldable animal sustenance receptacle 200 comprises a wall mountable structure 101 having a front face 102 shaped in the silhouette of a dog with a platform 104 operably attached to the front face 102. As shown in FIG. 2, the platform shape partially mimics the silhouette of the front face 102 of the wall mountable structure 101, so that the silhouette of a dog is maintained when the platform is in the folded or closed position. The foldable animal sustenance receptacle further comprises receptacles 106 that may act as containers for food or water.

Shown in FIGS. 1 and 2, the receptacle platform 104 may comprise an opening such that the receptacle 106 fits and is held within the opening. Receptacles 106 may also be placed on top of the platform 104. The receptacle 106 may be separate from the platform 104, or may be permanently or semi-permanently attached to the platform 104.

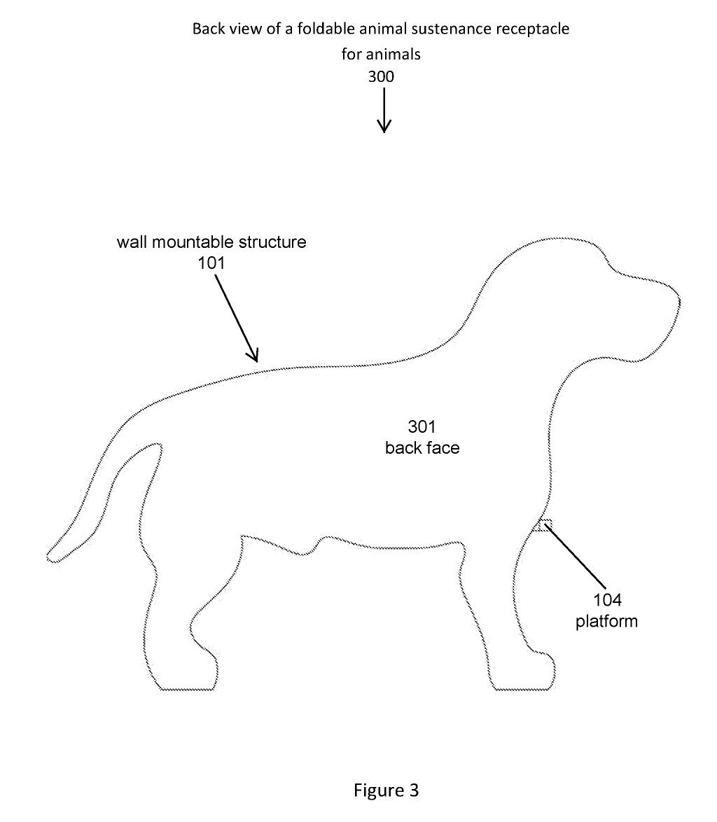

FIG. 3 shows the back view of the foldable animal sustenance receptacle 300 shown in FIGS. 1 and 2. Though not shown in FIG. 3, the back face 301 of the foldable animal sustenance receptacle may further comprise a means for attaching the apparatus to a wall.

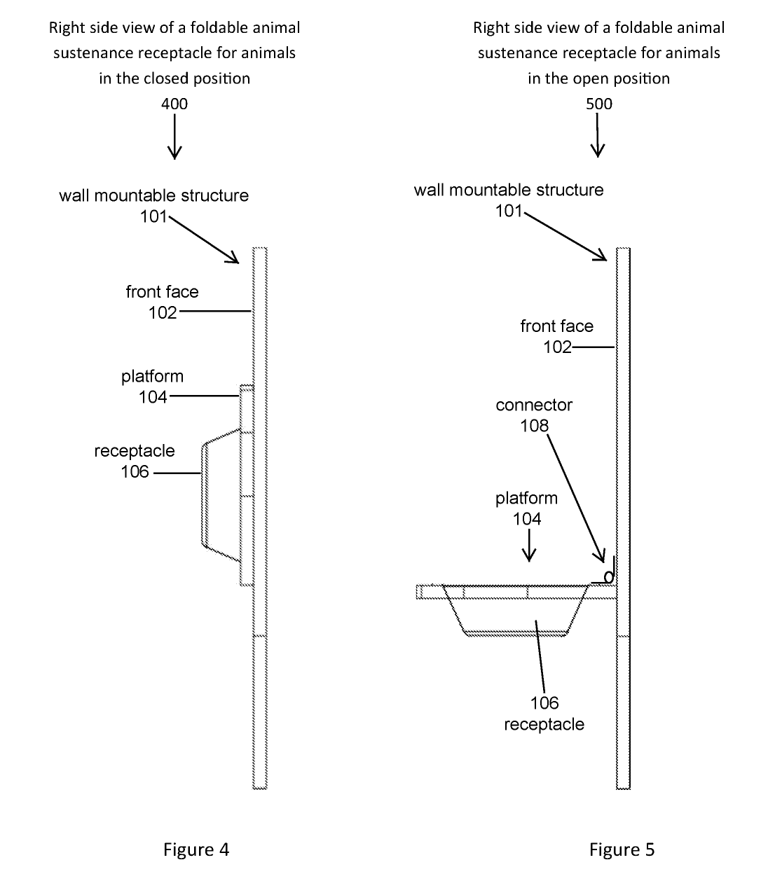

FIGS. 4 and 5 show right side views the foldable animal sustenance receptacle in the closed 400 and open 500 positions. As shown in FIG. 4, the platform 104 is folded and in the vertical or closed position and is substantially flush with the front face 102.

As shown in FIG. 5, the platform 104 is unfolded and in the horizontal or open position. The platform is approximately perpendicular to the front face 102, however the platform may unfold at an angle of between 80 and 100 degrees relative to the front face 102.

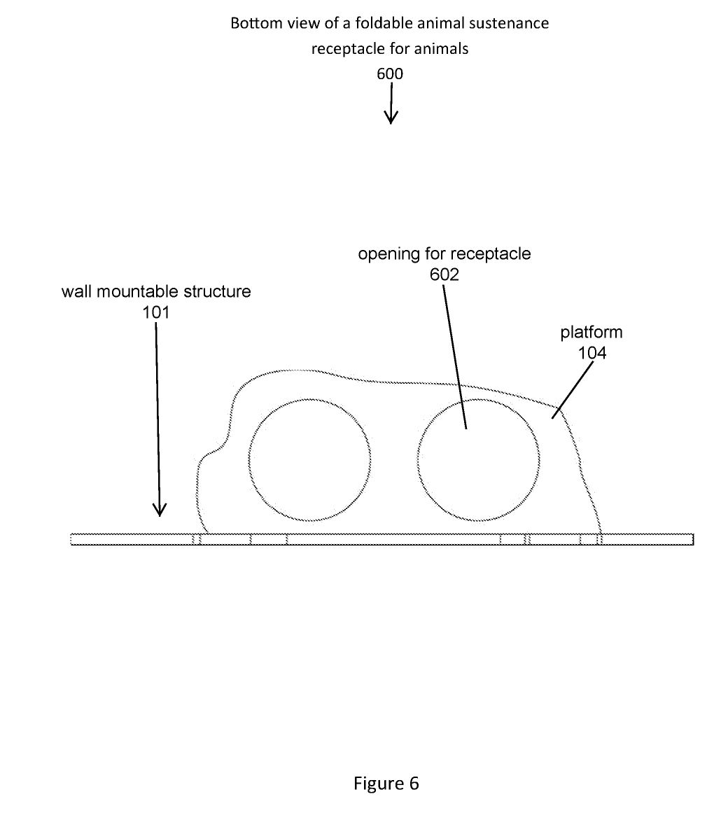

FIG. 6 shows the bottom view 600 of a foldable animal sustenance receptacle for animals. As shown in FIG. 6, the receptacle platform 104 is a shape that substantially corresponds to and mimics the shape of the front face, so that the silhouette of the animal is maintained when in the receptacle platform is in the folded or closed position. However, as will be understood by one skilled in the art any number of shapes may be used for the platform 104. Also shown in FIG. 6 is an opening 602 within the platform 104 for receptacles.

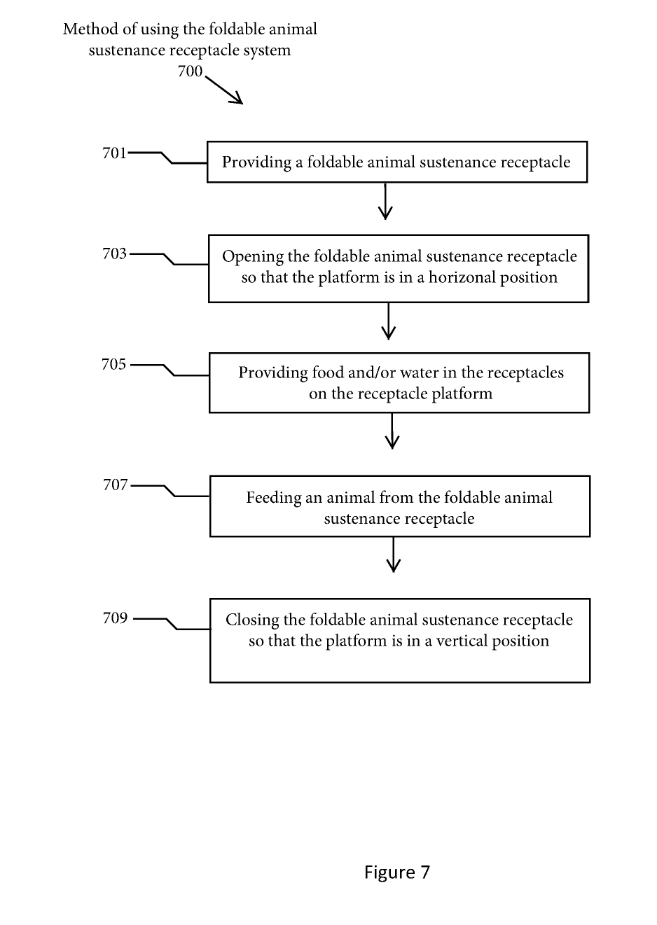

FIG. 7 provides a flow diagram of a method of using the foldable animal sustenance receptacle system. In step 701, a foldable animal sustenance receptacle is provided. As shown in FIGS. 1 and 2 and discussed previously, the platform contains at least one receptacle on or within the receptacle platform and the platform is attached to a wall mountable structure by a hinge, for example, with the receptacle platform in a vertical position, closed position and is substantially flush against the wall mountable structure. In step 703, the receptacle platform is opened, or rotated downward from a vertical, closed position to a horizontal, open position. In step 705 food and/or water is then provided in the at least one receptacle within the receptacle platform. In step 707 the animal is allowed to feed. In step 709, the receptacle platform is rotated upwards from the horizontal position back to the vertical, closed position.

While a receptacle platform that rotates downwards from a vertical position is discussed in the flow diagram of FIG. 7, it should be understood by one skilled in the art that the receptacle platform may also rotate upwards from the vertical position, depending on how the platform is operably attached to the wall mountable structure.

### EXAMPLES

The following examples are provided to illustrate further the various applications of the present invention and are not intended to limit the invention beyond the limitations set forth in the appended claims.

### Example 1

### Foldable Animal Sustenance Receptacle in the Silhouette of a Cat

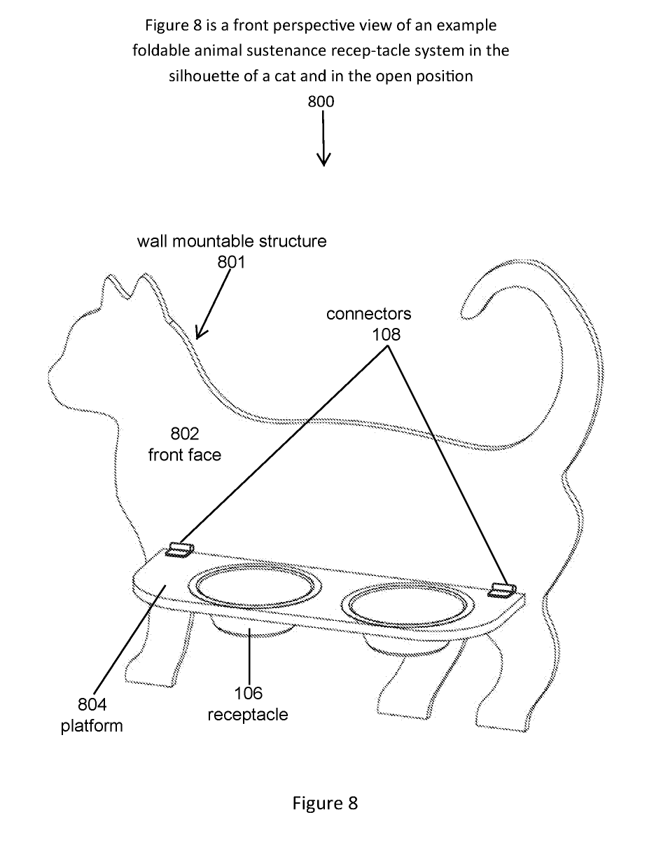

Shown in FIG. 8 is a front perspective view of a foldable animal sustenance receptacle for animals in the silhouette of a cat and in the open position 800. The foldable animal sustenance receptacle 800 comprises a wall mountable structure 801 having a front face 802 shaped in the silhouette of a cat with a platform 804 operably attached to the front face 802 by connectors 108. The platform shape partially mimics the silhouette of the front face 802 of the wall mountable structure 801, so that the silhouette of a cat is maintained when the platform 104 is in the folded or closed position. The foldable animal sustenance receptacle for cats further comprises receptacles 106 that may act as containers for food or water.

While a cat is shown in FIG. 8, the foldable animal sustenance receptacle of the present disclosure may be used for variety of animals, including but not limited to, dogs, cats, horses, cattle, ox, goats, sheep, donkeys, mules, camels, llamas, alpacas, and pigs.

### Example 2

### Horse or Dairy Cattle Barn

In another example, the receptacle platform of the present disclosure is attached to the interior wall of a barn, such as the wall of a stall, for use in feeding horses, dairy cattle or other livestock. In this example, the receptacle platform is attached directly to a wall and not to wall mountable structure. The means of attaching the receptacle platform to the barn wall may be a hinge or other means. The receptacle platform may be rotated from a vertical, closed position flush against the wall for easy storage to a horizontal, open position for animal feeding and watering.

### Example 3

### Animal or Horse Trailers

In another example, the receptacle platform of the present disclosure is attached to the interior wall of an animal trailer, such as the interior wall of a horse trailer, for use in feeding horses, dairy cattle or other livestock. In this example, the receptacle platform is attached directly to a wall and not to the wall mountable structure. The means of attaching the receptacle platform to the interior wall may be a hinge or other means. The receptacle platform may be rotated from a vertical, closed position flush against the wall for easy storage to a horizontal, open position for animal feeding and watering.

### Example 4

### Animal Kennels or Boarding Facilities

In another example, one or more receptacle platforms of the present disclosure may be used in an animal kennel within an animal boarding facility. In this example, one or more receptacle platforms are attached to the interior wall of an animal boarding facility. In this example, the receptacle platform is attached directly to a wall and not to the wall mountable structure. The means of attaching the receptacle platform to the wall may be a hinge or other means. The receptacle platform may be rotated from a vertical, closed position flush against the wall for easy storage to a horizontal, open position for animal feeding and watering.

### Example 4

### Animal Feed Lot

In another example, the receptacle platform of the present disclosure is attached to the interior wall, fence, or post of an animal feedlot for use in feeding livestock. In this example, the receptacle platform is attached directly to a wall, fence, or post and not to a wall mountable platform. The means of attaching the receptacle platform to the wall or fence may be a hinge or other means. The receptacle platform may then be rotated from a vertical position flush against the wall for easy storage to a horizontal position for animal feeding and watering.

The foregoing description of the invention has been presented for purposes of illustration and description. It is not intended to be exhaustive or to limit the invention to the precise form disclosed, and other modifications and variations may be possible in light of the above teachings. The embodiment was chosen and described in order to best explain the principles of the invention and its practical application to thereby enable others skilled in the art to best utilize the invention in various embodiments and various modifications as are suited to the particular use contemplated. It is intended that the appended claims be construed to include other alternative embodiments of the invention except insofar as limited by the prior art.

What is claimed is:

1. A foldable animal sustenance receptacle comprising:
a wall mountable structure, having a front face and a back face; and
a receptacle platform comprising at least one receptacle for holding food or water;
wherein said receptacle platform is operably attached to said wall mountable structure by a means of attachment; and
wherein said means of attachment allows the receptacle platform to swing or rotate in a horizontal position, a vertical position, or any position between the horizontal position and the vertical position.

2. The foldable animal sustenance receptacle of claim 1, wherein said wall mountable structure is shaped in the silhouette of a domesticated animal.

3. The foldable animal sustenance receptacle of claim 1, wherein said receptacle is removable from said platform.

4. The foldable animal sustenance receptacle of claim 1, wherein said platform comprises at least one opening for said receptacle.

5. The foldable animal sustenance receptacle of claim 1, wherein said means of attachment is a hinge.

6. The foldable animal sustenance receptacle of claim 1, further comprising a means for supporting said platform when in the horizontal position.

7. The foldable animal sustenance receptacle of claim 6, wherein said means of support is a piston.

8. The foldable animal sustenance receptacle of claim 1, wherein the angle between said platform and said front face is between 80 and 100 degrees when in the horizontal position.

9. The foldable animal sustenance receptacle of claim 1, further comprising a means for attaching said back face to a wall.

10. The foldable animal sustenance receptacle of claim 1, further comprising one or more braces or legs, wherein said one or more braces or legs are operably coupled to said foldable animal sustenance receptacle in such a manner to support said foldable animal sustenance receptacle in the horizontal position.

11. A method for feeding a domestic animal comprising:
providing a foldable animal sustenance receptacle comprising:
a wall mountable structure, having a front face and a back face; and
a receptacle platform comprising at least one receptacle for holding food or water;
wherein said receptacle platform is operably attached to said wall mountable structure by a means of attachment; and
wherein said means of attachment allows the receptacle platform to swing or rotate in a horizontal position, a vertical position, or any position between the horizontal position and the vertical position;
rotating said receptacle platform from a closed position to an open position;
providing food or water in said receptacle;
feeding a domestic animal; and
returning said receptacle platform to a closed position.

12. The method of claim 11, wherein said wall mountable structure is shaped in the silhouette of a domesticated animal.

13. The method of claim 11, wherein said receptacle is removable from said platform.

14. The foldable animal sustenance receptacle of claim 11, wherein said platform comprises at least one opening for said receptacle.

15. The method of claim 11, wherein said platform is operably attached to said front face by a hinge.

16. The method of claim 11, further comprising a means for supporting said platform when in the horizontal position.

17. The method of claim 16, wherein said means of support is a piston.

18. The method of claim 11, wherein the angle between said platform and said front face is between 80 and 100 degrees when in the horizontal position.

19. The method of claim 11, further comprising a means for attaching said back face to a wall.

20. A foldable animal sustenance receptacle system, the system comprising:
a wall mountable structure, having a front face and a back face; and
a receptacle platform comprising at least one receptacle for holding food or water;
wherein said receptacle platform is operably attached to said wall mountable structure by a means of attachment; and
wherein said means of attachment allows the receptacle platform to swing or rotate in a horizontal position, a vertical position, or any position between the horizontal position and the vertical position.
